(19) United States
(12) Patent Application Publication
(10) Pub. No.: US 2018/0349822 A1
(43) Pub. Date: Dec. 6, 2018

(54) INTELLIGENT INSERTION OF CONSUMER INTO CONSUMER QUEUE

(71) Applicant: TimeTrade Systems, Inc., Tewksbury, MA (US)

(72) Inventor: Mukul Goyal, Tewksbury, MA (US)

(21) Appl. No.: 15/992,695

(22) Filed: May 30, 2018

Related U.S. Application Data
(60) Provisional application No. 62/512,397, filed on May 30, 2017.

(51) Int. Cl. G06Q 10/06; G07C 11/00; G06Q 10/02

(52) U.S. Cl. CPC G06Q 10/06311; G07C 2011/04; G06Q 10/02; G07C 11/00

(57) ABSTRACT

In one example embodiment, an intelligent queue manager obtains information relating to a scheduled appointment for a particular consumer to be serviced at a service location. The particular appointment is scheduled to occur at an appointment time. The intelligent queue manager monitors a consumer queue associated with the service location. The consumer queue indicates an order in which a plurality of consumers are each to be serviced at the service location. The plurality of consumers includes walk-in consumers and consumers with appointments. Based on the monitoring of the consumer queue, the intelligent queue manager predicts a current length of time required for a consumer to rise from a bottom of the consumer queue to a top of the consumer queue. At a time point preceding the appointment time by the current length of time, the intelligent queue manager inserts the particular consumer at the bottom of the consumer queue.

### CROSS REFERENCE TO RELATED APPLICATION

This application claims priority to U.S. Provisional Application No. 62/512,397, filed May 30, 2017, which is incorporated herein by reference.

### TECHNICAL FIELD

The present disclosure relates to consumer queuing.

### BACKGROUND

Many businesses have brick-and-mortar locations to provide services/sales to consumers/customers. Often, businesses permit consumers to schedule an appointment to receive a desired service. Businesses can also provide similar services to consumers who “walk in” without first scheduling an appointment.

### BRIEF DESCRIPTION OF THE DRAWINGS

FIG. 1 illustrates a system for intelligently managing a consumer queue, according to an example embodiment.

FIGS. 2A and 2B illustrate a consumer queue before and after a consumer is inserted therein, according to an example embodiment.

FIG. 3 is a block diagram of an intelligent queuing manager, according to an example embodiment.

FIG. 4 is a flowchart of a method for intelligently inserting a consumer into a consumer queue, according to an example embodiment.

### DESCRIPTION OF EXAMPLE EMBODIMENTS

### Overview

In one example embodiment, an intelligent queue manager obtains information relating to a scheduled appointment for a particular consumer to be serviced at a service location. The particular appointment is scheduled to occur at an appointment time. The intelligent queue manager monitors a consumer queue associated with the service location. The consumer queue indicates an order in which a plurality of consumers are each to be serviced at the service location, and the plurality of consumers includes walk-in consumers and consumers with appointments. Based on the monitoring of the consumer queue, the intelligent queue manager predicts a current length of time required for a consumer to rise from a bottom of the consumer queue to a top of the consumer queue. At a time point preceding the appointment time by the current length of time, the intelligent queue manager inserts the particular consumer at the bottom of the consumer queue.

### DETAILED DESCRIPTION

Typically, businesses can place walk-in consumers in a consumer queue to be serviced in a specified order (e.g., the order in which the walk-in consumers arrived at a location of the business). Walk-in consumers often wait in a consumer queue at the location for an extended period of time before receiving a desired service. Meanwhile, a consumer having an appointment may arrive at the location at the time of the appointment and receive the desired services immediately. Since the walk-in consumers in the consumer queue may be unaware that this consumer had scheduled an appointment, the walk-in consumers may not understand why the business provided the desired services to the consumer with the appointment before the other consumers who had been waiting in the consumer queue. This can create a perceived lack of fairness with regard to the order in which services are rendered from the perspective of the walk-in consumers.

As such, techniques are provided herein to automatically and intelligently insert consumers with previously scheduled appointments into a consumer queue. Briefly, a consumer queue having both walk-in and previously scheduled appointment information provides notice to the walk-in consumers in the consumer queue of upcoming scheduled appointments. An intelligent queue manager is provided that predicts how long in advance to insert a consumer with an appointment into the consumer queue so that the consumer rises to the top of the queue as close to the consumer appointment time as possible. This addresses the perceived lack of fairness created by conventional consumer queuing techniques because the business may no longer appear to provide desired services “out of order.”

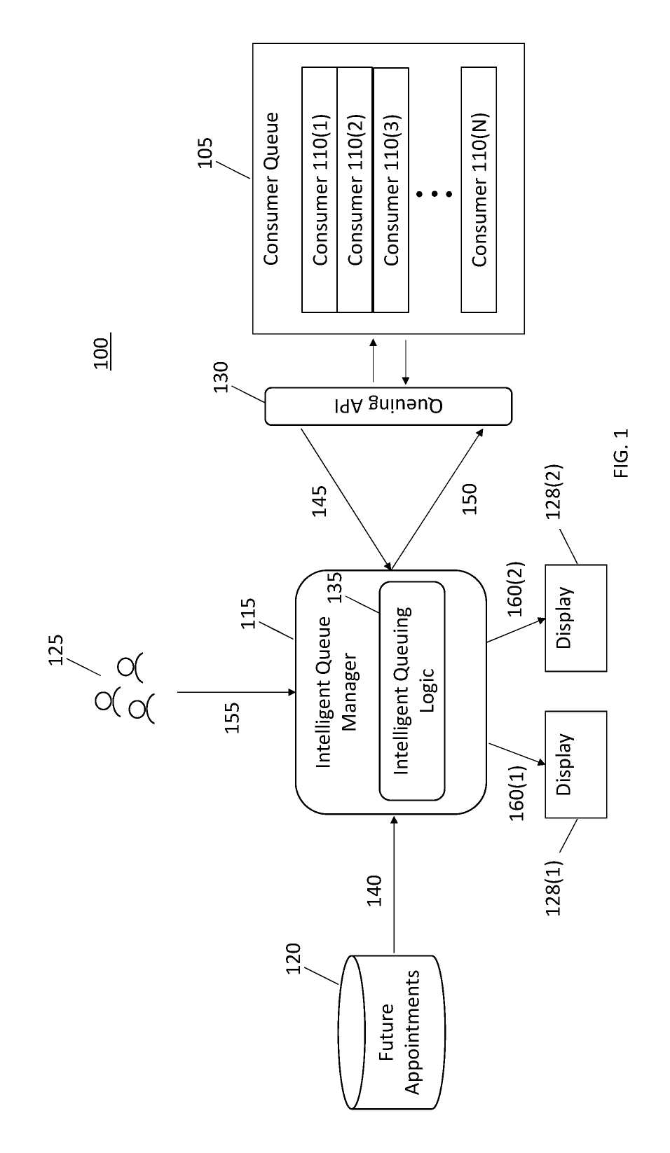

FIG. 1 illustrates a system 100 for intelligently managing a consumer queue 105 associated with a service location and indicating an order in which a plurality of consumers 110(1)-110(N) are each to be serviced at the service location. The environment includes an intelligent queue manager 115 configured to communicate with a repository (e.g., database) of future appointments 120, business staff 125 (i.e., employees of the business servicing the consumers), displays 128(1) and 128(2), and the consumer queue 105. A queuing application program interface (API) 130 enables communication between the intelligent queue manager 115 and the consumer queue 105. The intelligent queue manager 115 includes intelligent queuing logic 135 to enable the intelligent queue manager to perform operations described herein.

In the example of FIG. 1, the intelligent queue manager 110 monitors the repository 110 for future appointments (i.e., appointments that consumers have scheduled but which have not yet occurred). At 140, the intelligent queue manager 110 may thereby obtain information relating to a particular appointment for a particular consumer to be serviced at a service location, where the particular appointment is scheduled to occur at an appointment time (e.g., sometime in the future). At 145, the intelligent queue manager 115 may monitor the consumer queue 105 in order to, for example, obtain queuing information (e.g., current wait times) from the consumer queue 105 via the queuing API 130. Based on monitoring the consumer queue 105, the intelligent queue manager 115 may predict a current length of time required for a consumer to rise from a bottom of the consumer queue to a top of the consumer queue. At 150, at a time point preceding the appointment time by the current length of time, the intelligent queue manager 115 may insert the particular consumer at the bottom of the consumer queue 105. Insertion may occur before the actual appointment time or at the appointment time.

The plurality of consumers 110(1)-110(N) may include walk-in consumers and consumers with appointments. To prevent the walk-in consumers from experiencing the perceived lack of fairness described above, the intelligent queue manager 115 may further display, at 160(1) and 160(2), a representation of the consumer queue 105 on a display screen at the service location (e.g., display 128(1)), on the display screen of a mobile device associated with one or more of the plurality of consumers 110(1)-110(N) (e.g., display 128(2)), television, computer monitor, etc. In one example, the consumer queue 105 may comprise a mobile application and be represented on a heads-up display. The display enables walk-in consumers to view a representation of the consumer queue 105 and thereby determine in advance how many consumers (including consumers with appointments) are scheduled to be serviced first in the consumer queue 105. Thus, walk-in consumers may see every consumer (including those with appointments) ahead of them in the consumer queue 105.

The intelligent queue manager 115 may monitor the consumer queue 105 for any suitable queuing information. In one example, monitoring the consumer queue 105 may include monitoring the consumer queue 105 for information regarding an addition of one or more appointments in the consumer queue 105 (e.g., an addition may indicate that the particular consumer will move up the consumer queue 105 more slowly, and therefore shorten the time until the intelligent queue manager 115 inserts the particular consumer). In another example, monitoring the consumer queue 105 may include monitoring the consumer queue 105 for information regarding a cancellation of one or more appointments in the consumer queue 105 (e.g., a cancellation may indicate that the particular consumer will move up the consumer queue 105 more quickly, and therefore extend the time until the intelligent queue manager 115 inserts the particular consumer).

In yet another example, monitoring the consumer queue 105 may include monitoring the consumer queue 105 for information regarding a change in time of one or more appointments in the consumer queue. For instance, if a consumer originally has an appointment scheduled for before the particular consumer's appointment and then reschedules his or her appointment for after the particular consumer's appointment, this may indicate that the particular consumer will move up the consumer queue 105 more quickly, and therefore extend the time until the intelligent queue manager 115 inserts the particular consumer. Similarly, if a consumer originally has an appointment scheduled for after the particular consumer's appointment and then reschedules his or her appointment for before the particular consumer's appointment, this may indicate that the particular consumer will move up the consumer queue 105 more slowly, and therefore shorten the time until the intelligent queue manager 115 inserts the particular consumer.

The intelligent queue manager 115 may predict a current length of time required for a consumer to rise from the bottom of the consumer queue 105 to the top of the consumer queue based on any of one or more factors. In one example, the intelligent queue manager 115 may predict the current length of time based on historical data relating to the appointment time. This may include the time of day, the day of the week, the time of year, etc. For example, if the particular appointment is scheduled for an historically busy time of day (e.g., just before closing), day of the week (e.g., mid-week), or time of year (e.g., holiday season), the particular consumer may be expected to move up the consumer queue 105 more slowly. Meanwhile, if the particular appointment is scheduled for an historically slow time of day (e.g., mid-day), day of the week (e.g., early week), or time of year (e.g., winter), the particular consumer may be expected to move up the consumer queue 105 more quickly.

In another example, the intelligent queue manager 115 may predict the current length of time based on types of services provided to consumers at the service location (e.g., a hair salon appointment may generally take longer than a fast food pickup appointment). In another example, the intelligent queue manager 115 may predict the current length of time based on the service location (e.g., a service location in a densely populated area, such as downtown in a city, may have more walk-in consumers than a store located in a lightly populated area). In yet another example, the intelligent queue manager 115 may predict the current length of time based on types of services that are to be provided to the plurality of consumers (e.g., an appointment to purchase a phone may be shorter than an appointment to repair a phone).

In another example, predicting a current length of time required for a consumer to rise from the bottom of the consumer queue 105 to the top of the consumer queue 105 may include analyzing staff availability information for the service location during the current length of time. For instance, at 155, the intelligent queue manager 115 may receive staff availability information from the business servicing the plurality of consumers 110(1)-110(N) (e.g., from business staff 125). The updates may include information regarding staff availability. In one example, the staff availability information may include a number of staff available to service consumers at the service location during the current length of time. In this example, low staff availability may indicate that the particular consumer will move up the consumer queue 105 more slowly, and therefore shorten the time until the intelligent queue manager 115 inserts the particular consumer. In another example, staff availability information may include historical information indicating an efficiency of staff in servicing consumers at the service location. In this example, a more efficient (e.g., experienced) staff member may be expected to have shorter appointments than a less efficient staff member. If the staff is more efficient, this indicates that the particular consumer will move up the consumer queue 105 more quickly, and therefore increase the time until the intelligent queue manager 115 inserts the particular consumer.

Accordingly, based on repository 120, updates 155 from business staff 125, and queuing information 145, the intelligent queue manager 115 may determine an optimal time at which to insert respective appointments into the consumer queue 105. The intelligent queue manager 115 may holistically determine the insert time based on, for example, staff schedules/availability, individual prioritization, service type, current wait times, a change in the consumer queue 105 (e.g., addition/cancellation of appointment), historical data, potential delays (e.g., due to traffic/weather/local events) etc. It will be appreciated that a business may configure/customize this determination according to the particular preferences of the business. At the appropriate time, the intelligent queue manager 115 may insert the appointment(s) into the consumer queue 105 via the queuing API 130.

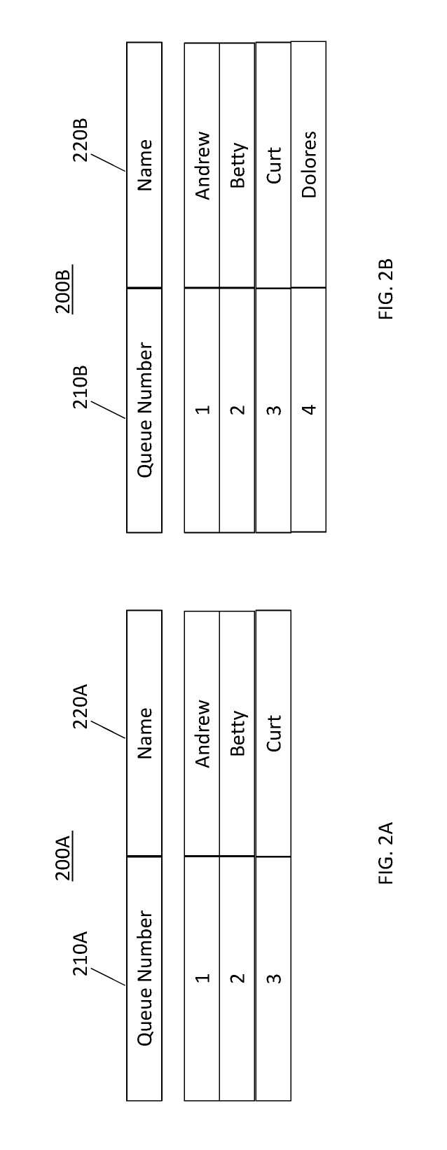

FIGS. 2A and 2B illustrate a consumer queue before and after a consumer is inserted therein. The consumer queue may be similar to consumer queue 105. Turning first to FIG. 2A, shown is a consumer queue 200A before a consumer is inserted therein. Consumer queue 200A includes queue number column 210A and name column 220A. A representation of consumer queue 200A may be displayed on a display screen. As shown, Andrew is at the top of the consumer queue 200A because he is at queue number 1 and is thus the next consumer in the consumer queue 200A to be serviced. Betty is at queue number 2 and is thus the next consumer after Andrew in the consumer queue 200A to be serviced. Curt is at the bottom of the consumer queue 200A because he is at queue number 3 and is thus the last consumer in the consumer queue 200A to be serviced.

A fourth consumer, Dolores, may schedule an appointment for 2:00 pm at the same service location as Andrew, Betty, and Curt. The intelligent queue manager 115 may learn of this appointment by monitoring repository 120. The intelligent queue manager 115 obtains queuing information 145 from the consumer queue 105 via the queuing API 130 (and possibly staff availability 155 from business staff 125). The intelligent queue manager 115 determines the time at which Dolores' appointment needs to be placed at the bottom of the consumer queue 200A in order to reach the top at 2:00 pm, and inserts Dolores' appointment in the consumer queue 200A at that time.

FIG. 2B illustrates consumer queue 200B after Dolores is inserted therein. Consumer queue 200B includes queue number column 210B and name column 220B. Consumer queue 200B is identical to consumer queue 200A, except that Dolores has been inserted at the bottom of the consumer queue 200B at the appropriate time. For instance, if the intelligent queue manager 115 determines that the typical/average slot in the consumer queue 200A will move from the bottom of the consumer queue 200A to the top of the consumer queue 200A in one hour, the intelligent queue manager 115 may insert Dolores' appointment in the consumer queue 200A at 1:00 pm (regardless of when Dolores actually scheduled her appointment, e.g., the same day, one week ago, one month ago, etc.). Thus, Dolores' 2:00 pm appointment will reach the top of the consumer queue 200B at 2:00 pm, and the walk-in consumers in the consumer queue 200B will have notice of the 2:00 pm appointment.

In another example use case, a consumer may leave an item (e.g., a phone) at a location to be serviced (e.g., repaired). In this example, the intelligent queue manager 115 may determine that the service engineer at the location will require one hour to repair the phone, and that the typical slot in the consumer queue will move from the bottom of the consumer queue to the top of the consumer queue in forty-five minutes. The intelligent queue manager thus generates and inserts an appointment for the consumer into the consumer queue forty-five minutes before the service is complete (i.e., fifteen minutes into the repair).

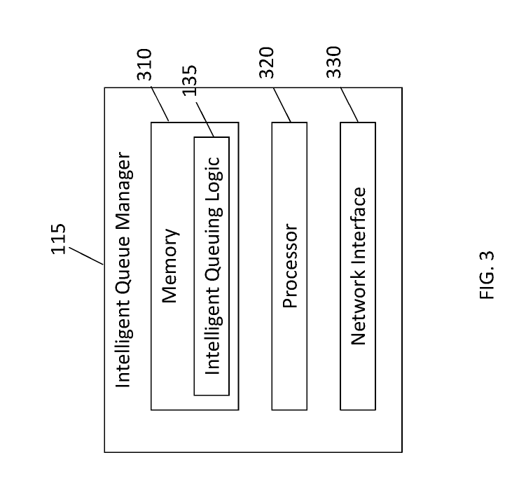

FIG. 3 is a simplified block diagram of intelligent queue manager 115 configured to implement the techniques presented herein. In this example, the intelligent queue manager 115 includes a memory 310 that stores instructions for intelligent queuing logic 135, one or more processors 320, and a network interface 330. The one or more processors 320 are configured to execute instructions stored in the memory 310 for the intelligent queuing logic 135. When executed by the one or more processors 320, the intelligent queuing logic 135 causes the intelligent queue manager 115 to perform operations described herein. The network interface 330 is a network interface card (or multiple instances of such a device) or other network interface device that enables network communications on behalf of the intelligent queue manager 115 for sending and receiving messages as described above.

The memory 310 may be read only memory (ROM), random access memory (RAM), magnetic disk storage media devices, optical storage media devices, flash memory devices, electrical, optical, or other physical/tangible memory storage devices. Thus, in general, the memory 310 may be one or more tangible (non-transitory) computer readable storage media (e.g., a memory device) encoded with software comprising computer executable instructions and when the software is executed (by the processor 320) it is operable to perform operations described herein.

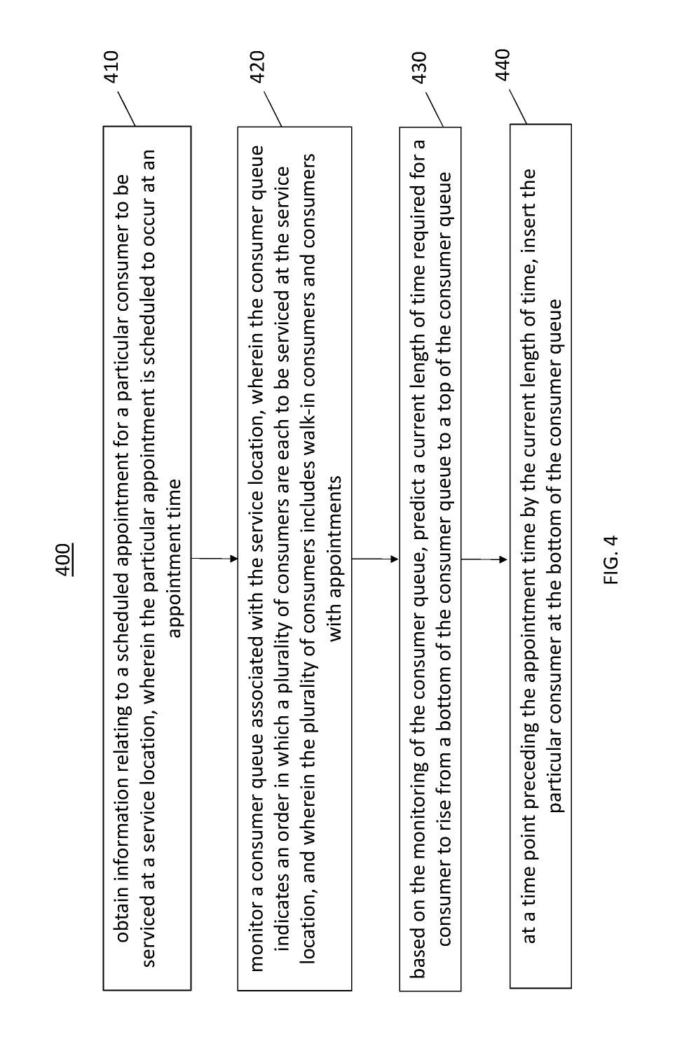

FIG. 4 is a flowchart of a method 400 for intelligently inserting a consumer into a consumer queue. Method 400 may be performed by intelligent queue manager 115, for example. At 410, intelligent queue manager 115 obtains information relating to a scheduled appointment for a particular consumer to be serviced at a service location, wherein the particular appointment is scheduled to occur at an appointment time. At 420, intelligent queue manager 115 a consumer queue associated with the service location, wherein the consumer queue indicates an order in which a plurality of consumers are each to be serviced at the service location, and wherein the plurality of consumers includes walk-in consumers and consumers with appointments. At 430, based on the monitoring of the consumer queue, intelligent queue manager 115 predicts a current length of time required for a consumer to rise from a bottom of the consumer queue to a top of the consumer queue. At 440, at a time point preceding the appointment time by the current length of time, intelligent queue manager 115 inserts the particular consumer at the bottom of the consumer queue.

In one form, a method is provided. The method comprises: obtaining information relating to a scheduled appointment for a particular consumer to be serviced at a service location, wherein the particular appointment is scheduled to occur at an appointment time; monitoring a consumer queue associated with the service location, wherein the consumer queue indicates an order in which a plurality of consumers are each to be serviced at the service location, and wherein the plurality of consumers includes walk-in consumers and consumers with appointments; based on the monitoring of the consumer queue, predicting a current length of time required for a consumer to rise from a bottom of the consumer queue to a top of the consumer queue; and at a time point preceding the appointment time by the current length of time, inserting the particular consumer at the bottom of the consumer queue.

In another form, an apparatus is provided. The apparatus comprises: a network interface configure to obtain information relating to a scheduled appointment for a particular consumer to be serviced at a service location, wherein the particular appointment is scheduled to occur at an appointment time; and a processor configured to: monitor a consumer queue associated with the service location, wherein the consumer queue indicates an order in which a plurality of consumers are each to be serviced at the service location, and wherein the plurality of consumers includes walk-in consumers and consumers with appointments; based on the monitoring of the consumer queue, predict a current length of time required for a consumer to rise from a bottom of the consumer queue to a top of the consumer queue; and at a time point preceding the appointment time by the current length of time, insert the particular consumer at the bottom of the consumer queue.

In another form, one or more non-transitory computer readable storage media are provided. The non-transitory computer readable storage media are encoded with instructions that, when executed by a processor, cause the processor to: obtain information relating to a scheduled appointment for a particular consumer to be serviced at a service location, wherein the particular appointment is scheduled to occur at an appointment time; monitor a consumer queue associated with the service location, wherein the consumer queue indicates an order in which a plurality of consumers are each to be serviced at the service location, and wherein the plurality of consumers includes walk-in consumers and consumers with appointments; based on the monitoring of the consumer queue, predict a current length of time required for a consumer to rise from a bottom of the consumer queue to a top of the consumer queue; and at a time point preceding the appointment time by the current length of time, insert the particular consumer at the bottom of the consumer queue.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining information relating to a scheduled appointment for a particular consumer to be serviced at a service location, wherein the particular appointment is scheduled to occur at an appointment time;
monitoring a consumer queue associated with the service location, wherein the consumer queue indicates an order in which a plurality of consumers are each to be serviced at the service location, and wherein the plurality of consumers includes walk-in consumers and consumers with appointments;
based on the monitoring of the consumer queue, predicting a current length of time required for a consumer to rise from a bottom of the consumer queue to a top of the consumer queue; and
at a time point preceding the appointment time by the current length of time, inserting the particular consumer at the bottom of the consumer queue.

2. The method of claim 1, wherein predicting a current length of time required for a consumer to rise from a bottom of the consumer queue to a top of the consumer queue includes:
analyzing staff availability information for the service location during the current length of time.

3. The method of claim 2, wherein the staff availability information includes an indication of a number of staff available to service consumers at the service location during the current length of time.

4. The method of claim 2, wherein the staff availability information includes historical information indicating an efficiency of staff in servicing consumers at the service location.

5. The method of claim 1, wherein monitoring the consumer queue includes monitoring the consumer queue for information regarding a cancellation of one or more appointments in the consumer queue.

6. The method of claim 1, wherein monitoring the consumer queue includes monitoring the consumer queue for information regarding an addition of one or more appointments to the consumer queue.

7. The method of claim 1, wherein monitoring the consumer queue includes monitoring the consumer queue for information regarding a change in time of one or more appointments in the consumer queue.

8. The method of claim 1, wherein predicting a current length of time required for a consumer to rise from a bottom of the consumer queue to a top of the consumer queue includes:
predicting the current length of time based on historical data relating to the appointment time.

9. The method of claim 1, wherein predicting a current length of time required for a consumer to rise from a bottom of the consumer queue to a top of the consumer queue includes:
predicting the current length of time based on types of services provided to consumers at the service location.

10. The method of claim 1, wherein predicting a current length of time required for a consumer to rise from a bottom of the consumer queue to a top of the consumer queue includes:
predicting the current length of time based on the service location.

11. The method of claim 1, wherein predicting a current length of time required for a consumer to rise from a bottom of the consumer queue to a top of the consumer queue includes:
predicting the current length of time based on types of services that are to be provided to the plurality of consumers.

12. The method of claim 1, further comprising:
displaying a representation of the consumer queue on a display screen at the service location.

13. The method of claim 1, further comprising:
causing a representation of the consumer queue to be displayed at a display screen of a mobile computing device associated with one or more of the particular consumer or the plurality of consumers.

14. An apparatus comprising:
a network interface configure to obtain information relating to a scheduled appointment for a particular consumer to be serviced at a service location, wherein the particular appointment is scheduled to occur at an appointment time; and
a processor configured to:
monitor a consumer queue associated with the service location, wherein the consumer queue indicates an order in which a plurality of consumers are each to be serviced at the service location, and wherein the plurality of consumers includes walk-in consumers and consumers with appointments;
based on the monitoring of the consumer queue, predict a current length of time required for a consumer to rise from a bottom of the consumer queue to a top of the consumer queue; and
at a time point preceding the appointment time by the current length of time, insert the particular consumer at the bottom of the consumer queue.

15. The apparatus of claim 14, wherein the processor is further configured to:
analyze staff availability information for the service location during the current length of time.

16. The apparatus of claim 14, wherein the processor is further configured to:
predict the current length of time based on types of services provided to consumers at the service location.

17. The apparatus of claim 14, wherein the processor is further configured to:
predict the current length of time based on types of services that are to be provided to the plurality of consumers.

18. One or more non-transitory computer readable storage media encoded with instructions that, when executed by a processor, cause the processor to:
obtain information relating to a scheduled appointment for a particular consumer to be serviced at a service location, wherein the particular appointment is scheduled to occur at an appointment time;
monitor a consumer queue associated with the service location, wherein the consumer queue indicates an order in which a plurality of consumers are each to be serviced at the service location, and wherein the plurality of consumers includes walk-in consumers and consumers with appointments;
based on the monitoring of the consumer queue, predict a current length of time required for a consumer to rise from a bottom of the consumer queue to a top of the consumer queue; and
at a time point preceding the appointment time by the current length of time, insert the particular consumer at the bottom of the consumer queue.

19. The one or more non-transitory computer readable storage media of claim 18, wherein the instructions further cause the processor to:
predict the current length of time based on types of services provided to consumers at the service location.

20. The one or more non-transitory computer readable storage media of claim 18, wherein the instructions further cause the processor to:
predict the current length of time based on types of services that are to be provided to the plurality of consumers.
